(19) United States
(12) Patent Application Publication
(10) Pub. No.: US 2006/0020535 A1
(43) Pub. Date: Jan. 26, 2006

(54) Insurance for dollar equivalent stock certificates

(75) Inventor: George Pieczenik, New York, NY (US)

Correspondence Address: DR. GEORGE PIECZENIK, APT. 1F, 412 EAST 55TH STREET, NEW YORK, NY, 10022, US

(73) Assignee: Dr. George Pieczenik, New York, NY (US)

(21) Appl. No.: 10/710,857

(22) Filed: Aug. 8, 2004

Related U.S. Application Data
(62) Division of application No. 10/710,540, filed on Jul. 20, 2004.

(51) Int. Cl. G06Q 40/00

(52) U.S. Cl. 705/37

(57) ABSTRACT

Insuring a product and method of electronically trading stocks globally on their respective exchanges using a common currency, preferably U.S. currency.

This application claims priority from patent application Ser. No. 10,710,540, titled Global Stock Trading with Uniform Monetization filed Jul. 20, 2004 by Dr. George Pieczenik.

No federal funds were used in developing this inventions

Stocks are traded in many countries in many different currencies. For example, the New York Stock Exchange and the NASDAQ trade in U.S. dollars, while the French Stock exchange, Compagnie des Agents de Change 40 (CAC-40), trades in Euros. There is no uniform currency to trade stocks from different stock exchanges. An American trader, for example, cannot trade French stocks in dollar equivalents. At present a trader needs to trade in the currency of each countries stock exchange. For example, if the trader wants the dollar equivalent of the Euro, then he must purchase the equivalent dollars at a currency exchange for Euros.

Patent application by Inventor Bea Calo No. 20020087454 published Jul. 4, 2002 describes a global trading system. However, this system does not allow trading on global exchanges with a common currency.

There is a clear utility to creating a global trading system that can be traded in a uniform currency preferably the U.S. dollar. This will allow Americans to trade on the French, German, Russian, Chinese, Japanese, Brazilian, Indian, inter alia exchanges in U.S. dollars and will allow foreign nationals to trade in their countries their own stocks in dollars and on the US exchanges in dollars. The utility to for the American trader is easy access and trading in emerging foreign stock exchanges. The utility to foreign traders is to have stock assets in U.S. dollars.

The utility to commerce is to help globalize the stock exchanges of the world into a uniform market.

In the best mode, the common currency is the U.S. dollar.

In other embodiments, the common currency can be the Euro or gold, inter alia

The product for global stock trading in a common currency is a novel commercial paper document secured by an individual or corporation to convert the foreign stock price at its price into its dollar equivalent and to pay the bearer of said commercial paper document the U.S. dollar equivalent of the foreign shares owned.

This invention comprises a method for the uniform trading of foreign securities on their respective foreign stock exchanges comprising the steps of 1) presenting all stocks from all stock exchanges (U.S and foreign), or a representation of the same, on an electronic trading system, comprising a server and trading platforms which are accessible to a plurality of traders; and 2) wherein, said electronic trading system converts all foreign stocks from all foreign exchanges into their dollar equivalent; and 3) allowing traders to buy and sell these foreign stocks on said electronic trading system in their dollar equivalent; and 4) the step of allowing traders to accept the stock traded in its currency of origin with a dollar equivalent stock certificate (DESC) by 5) allowing the traded stock to be converted into its dollar equivalent, thereby creating a method of uniform trading for global securities in U.S. dollars. For a specific example, Chugai, a pharmaceutical company trading on the Japanese Exchange, traded on Jul. 19, 2004 at 1645 yen. The Yen was trading at 108.79 yen per dollar. If a trader bought one share of Chugai he would be issued a DESC commercial paper for one stock of Chugai for the dollar equivalent of (1645 Yen divided by 108.79 yen per dollar) 15.12 dollars. The trader's trading platform and server would show Chugai (Japan) at 15.12 dollars rather than 1645 Yen as it is shown on its own Japanese exchange. At any time the trader can convert his share of Chugai into dollars by turning over his DESC and Chugai share (Japan), denominated in Yen to the individual, individuals, group or corporation willing to secure this conversion transaction.

In all cases of trading, while the examples above give final quotes for the day, an active ticker on the electronic trading platform and server can show both the bid and ask price for all foreign stocks in dollar equivalents and not just the final day sale price, as well as other pertinent information, inter alia.

Each Dollar Equivalent Stock Certificates or DESC can also be insured by various insurance companies which can issue a Certificate of Insurance for each DESC. The insurance companies can be companies such a Lloyds of London or American International Group, Inc (AIG), inter alia. Therefore, each Dollar Equivalent Security Certificate will also come with a Certificate of Insurance. The bearer can either redeem the stock certificate in dollar equivalents immediately with the underwriting company or apply to the insurance company for reimbursement of the equivalent. These Insurance Certificates are to be called Dollar Equivalent Stock Certificate Insurance Certificates or DESC Insurance Certificates.

The utility of this insurance and the DESC Insurance certificate is a greater degree of protection and reliability of reimbursement to the holder of the DESCs. This makes the commercial product of the DESCs a more secure, reliable, competitive and attractive investment.

1. A commercial paper product for global stock trading in a common currency comprising a novel commercial paper document, to be called a Dollar Equivalent Stock Certificate Insurance Certificate (DESC Insurance Certificate) secured by a reputable insurance company or corporation which insures the bearer the right to convert the foreign currency stock price into its dollar equivalent and to pay the bearer of said DESC Insurance Certificate the U.S. dollar equivalent of the foreign shares owned.

2. The DESC Insurance Certificate of claim 1 wherein the stock value is insured by a reputable insurance company or organization in the equivalent value in Euros.

3. The DESC Insurance Certificate of claim 1 wherein the stock value is insured by a reputable insurance company or organization in the equivalent value of gold.

4. This invention comprises a method for insuring the uniform trading of foreign securities on their respective foreign stock exchanges comprising the steps of 1) presenting all stocks from all stock exchanges (U.S and foreign), or a representation of the same, on an electronic trading system, comprising a server and trading platforms which are accessible to a plurality of traders; and 2) converting by said electronic trading system all foreign stocks from all foreign exchanges into their dollar equivalent; and 3) buying and selling these foreign stocks on said electronic trading system in their dollar equivalent; and 4) accepting the stock traded in its currency of origin with a dollar equivalent stock certificate (DESC); and 5) accepting said DESC with a dollar equivalent stock certificate insurance certificate of claim 1; and 6) converting the traded stock into its dollar equivalent by presenting said DESC and DESC Insurance Certificate to the insuring company, and, thereby, creating an insured method of uniform trading for global securities in U.S. dollars.
